(19) United States
(12) Patent Application Publication
(10) Pub. No.: US 2004/0111353 A1
(43) Pub. Date: Jun. 10, 2004

(54) System and method for managing investment information

(76) Inventors: Robert A. Ellis, San Jose, CA (US); Danilo Mendoza, San Jose, CA (US)

Correspondence Address: William J. Kolegraff, 3119 Turnberry Way, Jamul, CA, 91935, US

(21) Appl. No.: 10/725,177

(22) Filed: Dec. 1, 2003

Related U.S. Application Data
(60) Provisional application No. 60/430,527, filed on Dec. 3, 2002.

(51) Int. Cl. G06F 17/60

(52) U.S. Cl. 705/36

(57) ABSTRACT

A method for managing investment information operates on a computer system. The process enables members to gather, share, and use investment information in an automated environment. In particular, members provide target projections for the future value of an investment. The process also provides for rating members, and uses these ratings to facilitate analyzing and presenting the target projections provided by the members. The target projections from a member are also compared to actual values achieved by the investment, and that member's rating may be adjusted responsive to the comparison.

This application claims priority to U.S. patent application Ser. No. 60/430,527, filed Dec. 3, 2002, and entitled “A System and Method for Managing Investment Information”.

### BACKGROUND

The field of the present invention is computerized investment information management. More specifically, the present invention relates to multi-user computer systems configured to gather, analyze, and present investment information.

The efficient management and analysis of investment information is crucial to effective portfolio management. In the past, most investors relied on brokers, advisors, or other professionals to manage investment information. These professionals also assisted the investor in making investment decisions, and often arranged for the purchase and sale of the investment. However, such professionals may be biased to recommend the particular investments they sell, and since they likely have many clients, are not able to devote sufficient time to customize an investment plan for every individual client.

Individual investors, therefore, have been driven to take more control of their investment portfolio and decisions. The effective and efficient management of a portfolio requires access to information, which has become readily available through the Internet. Investors now have a plethora of resources available, such as real-time stock quotes, immediate access to SEC filings, and on-line newsletters and advice columns. Too much information may overwhelm, confuse, and confound the individual investor. For example, the investor may be able to access and read a new SEC filing, but may not understand the financial and legal consequences. Accordingly, the investor will review advice columns and media reports to gauge the effect of the filing. These columns and reports often conflict, leading to even more confusion. Compounding the problem, it is difficult to assess the skill level, expertise, and bias of the people writing these columns and reports.

To sort out investment questions, investors have always communicated with each other, either formally or informally. These communications typically involve soliciting comments and advice from respected investment associates, friends, co-workers, family members, or other acquaintances. More recently, the Internet has facilitated such formal and informal communications, and greatly expanded the number of people that can exchange ideas. More particularly, there are several “discussion forums” on the Internet for discussing investment opportunities. These discussion forums allow users to “post” messages to a common area, where the message can be read by other users. Other users may respond by posting a reply message to the original post. As users continue to reply to the posts and build on each other's comments, a “thread” of messages is generated from the original post. Often, a particular discussion forum is focused on a particular investment, such as a stock for a specific company.

The discussion forum is useful for generally discussing investments, but the anonymity of the Internet raises concerns. First, since users posting messages are anonymous, and generally use code names to identify themselves, the trustworthiness of the poster cannot be readily gauged. It is therefore difficult, if not impossible, to know the skill level or expertise of the poster, or even if the poster could be trying to intentionally mislead the forum. Since all posts are suspect, the utility of the information is greatly hampered.

Another problem with discussion forums is that they often become uncivil, with angry or vulgar messages dominating the discussion. In this regard, a user may have to weed through dozens of inappropriate and useless messages to find messages with interesting insight and comments. Further, these discussion forums may be used to spread gossip about company executives, or start rumors regarding the investment. Due to the negativity of these discussions, companies often strongly discourage or prohibit their managers and executives from participating in discussion forums at all.

Finally, the discussion forum lacks a consistent mechanism to facilitate communication between users. There are limits to the preciseness of written language, and each user may have different interpretations of investment or legal words and phrases. In this regard, the information being provided by a user may be misunderstood by other users, leading to confusion, investment mistakes, or an ineffective investment process. The process is also inefficient as it can take hours of reading to decipher and understand meanings.

Therefore, there exists a need for a system that facilitates trusted communications regarding investments. It is desirable that these communications occur in a civil and professional environment, where users are encouraged to freely share information. Further, it would be desirable to have a systemic procedure for accurately and concisely sharing investment knowledge between users.

### SUMMARY

It is therefore an object of the present invention to overcome the deficiencies of known investment information management systems. It is a further object of the present invention to provide an effective and efficient environment to gather, analyze, and use investment information.

Briefly, the present invention provides a computer system operating an investment information management process. The process enables members to gather, share, analyze, and use investment information in an automated environment. In particular, members provide target projections for the future value of an investment. The process also provides for rating members, and uses these ratings to facilitate analyzing and presenting the target projections provided by the members. The target projections from a member are also compared to actual values achieved by the investment, and that member's rating may be adjusted responsive to the comparison.

In a preferred example of the method for managing investment information, the process initially registers a member and collects sufficient information to initially rate the investment skill level of the member. Once registered, the member is able to participate in on-line discussions regarding investment opportunities such as stock or other investment instrument. More particularly, the member is able to read and respond to postings in a discussion forum regarding a particular investment. The dialog in the discussion forum is monitored for civility by an automated rule-based system, and may also be human or systematically monitored to determine the quality of information provided by a member, with that member's rating being appropriately adjusted. Members in the forum also provide target projections for the value of the investment being discussed, and other members are enabled to analyze the target projections and ratings to better understand the consensus view of the investment. Additionally, each member using the forum is queried to input new target projections, with the new target projections, and that member's rating, being used to assist other members. Since the system retains a historical log of target projections, members' ratings may be adjusted according to their success in accurately projecting the value of the investment.

Advantageously, the disclosed method for managing investment information provides an adaptive environment for efficient sharing of investment information. For example, the members of a particular forum provide the basic information that other members will use to understand the future value of the investment being discussed. Information includes target projections, which provide a fast, convenient, consistent, objective, and unambiguous method of communicating between members. Over time, the process will identify members providing higher quality information, and efficiently give greater weight to the information provided by these members. In a similar fashion, those members who have been relatively unsuccessful in predicting future values will have less influence and credibility in the forum. The process, therefore, provides a civil environment for gathering, analyzing, and sharing information, and systematically provides an objective indication for the quality of the information.

### BRIEF DESCRIPTION OF THE DRAWINGS

FIG. 1 is a flowchart of a method for managing investment information in accordance with the present invention;

FIG. 2 is a flowchart of a method for managing investment information in accordance with the present invention;

FIG. 3 is a flowchart of a method for managing investment information in accordance with the present invention;

FIG. 4 is a representation of a user screen for registering a member in an investment forum in accordance with the present invention;

FIG. 5 is a representation of a user screen for receiving investment knowledge data from a new member in an investment forum in accordance with the present invention;

FIG. 6 is a list of example questions for rating the investment skill level of a new member in an investment forum in accordance with the present inventions;

FIG. 7 is a representation of a user screen for displaying posts and member information in an investment forum in accordance with the present invention;

FIG. 8 is a block diagram of a method and system for managing investment information in accordance with the present invention;

FIG. 9 is a representative input display for the method and system of FIG. 8;

FIG. 10 is a representative output display for the method and system of FIG. 8; and

FIG. 11 is a block diagram of a network system in accordance with the present invention.

### DETAILED DESCRIPTION

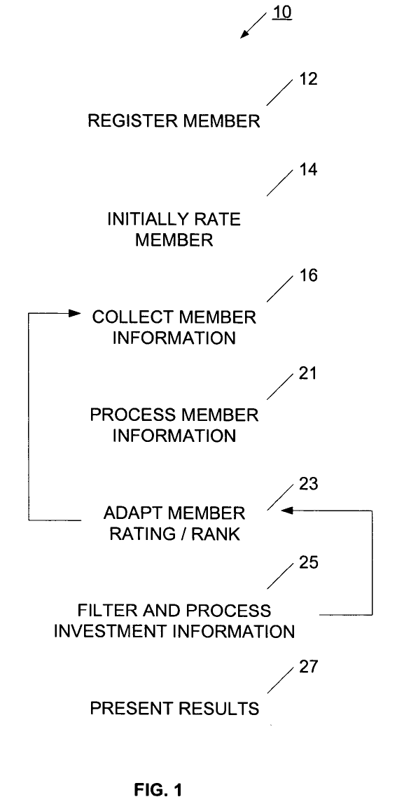

Referring now to FIG. 1, a method 10 for managing investment information is shown. Method 10 operates on a computer system, and enables multiple users to gather, share, analyze, and present investment information regarding multiple investment opportunities. In a particular example of method 10, the method 10 operates on an Internet server, with members accessing method 10 from client computing devices, such as personal computers or wireless Internet devices. It will be appreciated that other computer systems may be used, such as bulletin board systems, private networks, intranets, or other multi-user computer systems.

Method 10 is particularly suited to gather, share, analyze, and present information regarding investment opportunities. For example, method 10 may be configured for managing information about a single publicly traded stock, a group of related stocks, commodities, financial instruments, or even one or more private offerings. In another example, method 10 may permit sharing information on many stocks, such as all the stocks traded on the NASDAQ or New York Stock Exchange, or commodities or other investment instrument. It will be appreciated that method 10 could also be useful for other types of investments or investment information, such as commodity exchanges, currency exchanges, and foreign exchanges.

To participate in the method 10 for managing investment information, users first register to become members, as indicated in block 12. Registration typically involves providing basic identification and demographic information, and may include financial information, such as net worth and income information. Additionally, the registering member may be required to submit a fee, such as a monthly or access fee, to use the method 10. It will be appreciated that the information required in the registration step will vary depending on the particular investment opportunities managed by the method 10.

Once the basic registration information is received, the method 10 may query the new member for additional information to ascertain the new member's investment experience and skill level. For example, method 10 may provide a series of investment questions that the new member must answer, and then assign an initial rating 14 to the member responsive to the answers. For example, the member may be asked to provide information regarding how many years they have been investing and the number of shares traded each month. The method 10 may have a set of rules that analyze the response to each question, or recognize patterns in a series of questions, that may indicate a skill or knowledge level. In the present example, the method 10 may have a pre-defined rule that increases a new member rating proportional to the number of years of active trading, and similarly increase the new member rating proportional to number of stocks traded each month. The rules may apply, for example, a relative weighting scale to the questions and answers to assist in initially rating the member.

It will be appreciated that the specific questions presented will vary depending on the specific investment instrument. It will also be appreciated that the initial assessment of a members skill level is an imprecise determination, and that the predefined rules may be adjusted to reflect actual results obtained by individual members. For example, over time it may be shown that there is little correlation between the number of shares traded per month and a member's ability to provide quality information. In this regard, the rules could be modified to give little or no weighting or consideration to the level of trading when initially setting the new member rating.

When the member is registered and an initial rating set, then the member is permitted to participate in the method 10. For example, the member is able to provide information to other members. In providing this information, the information is collected from the member in block 16, and the member information is processed in block 21. In this regard, the member information may be made available to other members, either directly or as part of an aggregated result. The member information may be provided in several forms. For example, the information may be in the form of written dialog, with the member providing insight into a particular investment instrument or the investment environment in general. The information may also take the form of a target projection, where the member provides a speculation as to the value of an investment in the future. More specifically, the member may provide a target projection for the investment's value 2 weeks, 4 weeks, and 8 weeks in the future. It will be appreciated that other future times may be selected, either to facilitate shorter term or longer term investing. For example, a day trader may be interested in an investment's value predictions later that same day, while an institutional investor may be interested in speculations for a year or more in the future.

The method 10 obtains substantial investment information from members, either in dialog or target projection form. Preferably, information from members is retained to build a historical record of members' past target projections. Method 10 may also be pre-loaded with financial information, and may obtain additional information by connection to other on-line services, such as a real-time stock quotation service. Accordingly, method 10 may compare a particular member's historical target projections with actual investment values to obtain an indication of how accurately that member projected future value. Responsive to this comparison, method 10 may adapt 23 a particular member's rating. For example, a member that has been very accurate in predicting actual valuations for an investment may be given a higher rating, while a member that consistently grossly misses the actual valuation may be given a lower rating. It will be appreciated that a member may be rated differently for different investments, or that a single rating may be applied for all investments that member advises on. Additionally, method 10 may be configured so that substantial success in one investment will substantially increase that member's rating in that investment, raise the member's rating somewhat for investments in the same field, or only raise the member's rating slightly for all other investments that member advises on.

An active member using method 10 may also access investment information collected from other members. This investment information may be in the form of dialog, and may also include target projection information. To facilitate use of the investment information, a member may filter and process 25 the investment information to derive desired information. For example, a member may want to see what highly rated members project the value of the investment to be in 2 weeks. In another example, a member may review member dialog, and find that one or more members have particularly insightful comments. The member may therefore want to only see how accurately these insightful members have valued the investment over the past few weeks, and find how they value the investment weeks from now. Since the filtering and processing 25 step has access to historical member information, member rating information, and possibly other on-line information, it is possible to perform sophisticated searches to mine particular value from the investment information. It will be appreciated that such query and mining functions are readily supportable using known and widely available data processing tools, such as flat or relational databases.

Once the investment information has been mined, the results can be presented as indicated in block 27. For example, a member may choose to print or display dialog or target data, or may prefer chart or other graphical presentation. It will be appreciated that such presentation software and modules are known and widely available.

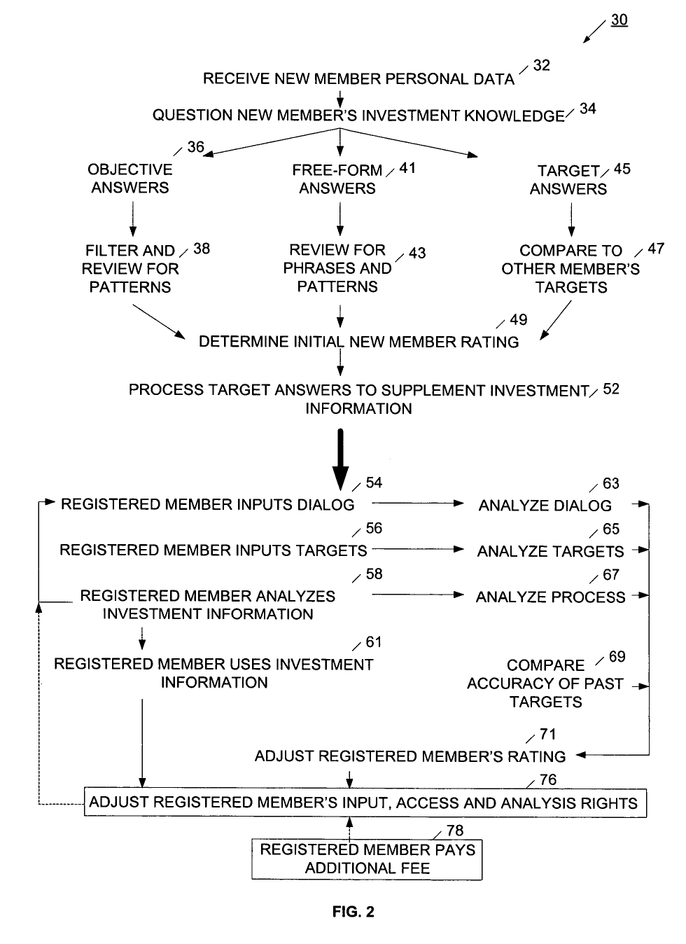

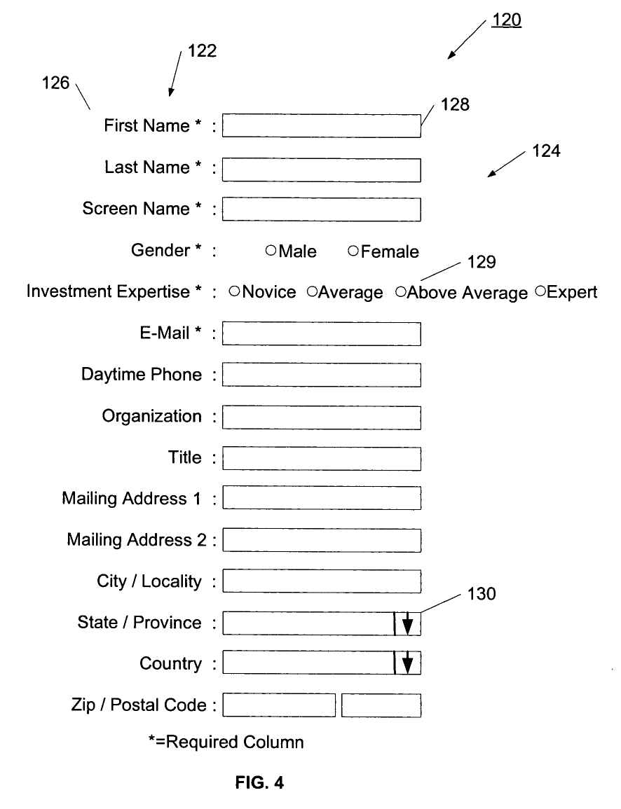

Referring now to FIG. 2, another method 30 for managing investment information is shown. Method 30 requests new member personal data as shown in block 32. The personal data may include identification, financial, and fee information, for example. FIG. 4 illustrates one possible screen 120 for inputting personal identification information. Screen 120 has a column of field identifiers 122, and a set of associated response blocks 124. For example, field identifier 126 requests the first name of the new member, and the new member will type their first name in response block 128. It will also be appreciated that other types of responses may be requested, such as having the member selecting one or more available radio buttons 129, or making specific selections from drop down boxes 130.

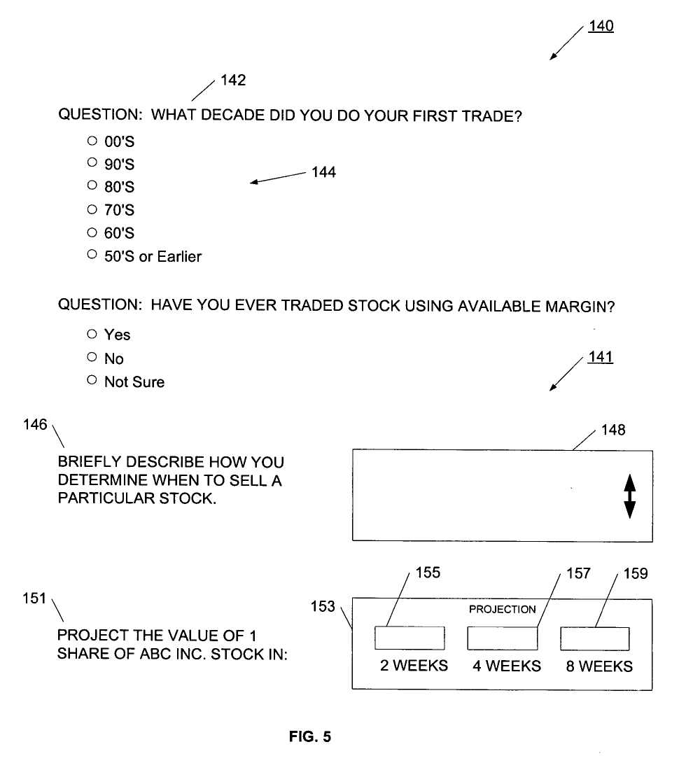

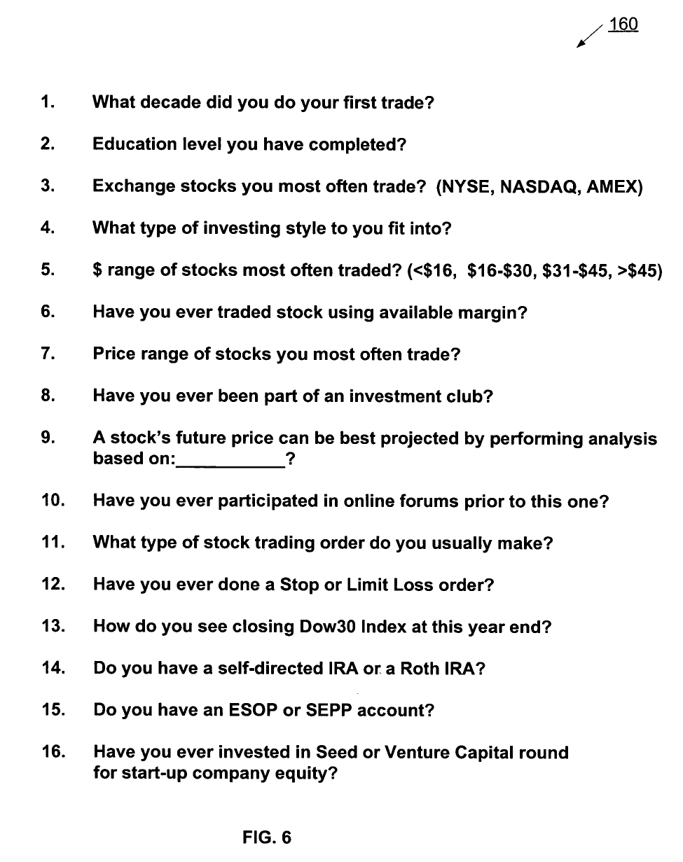

Further, the registration process includes ascertaining the new member's experience and knowledge in investing. In this regard, method 30 requires the new member to answer investment questions, as indicated in block 34 of FIG. 2. Although several types of questions are contemplated within the scope of this disclosure, method 30 illustrates questions having objective answers 36, questions having free-form answers 41, and questions having the new member provide target projections 45. For example, FIG. 5 shows a screen portion 140 having a question 142 where the new member selects an objective answer 144. More specifically, objective answer 144 is in the form of selectable radio buttons, although it will be appreciated that other types of object answer forms may be used, such as drop down boxes, check boxes, or numerical entry fields. Such objective answers are easy for a member to respond to, and provide information in a form that facilitates easy filtering and sorting. FIG. 6 shows a list of other examples of questions to interrogate investing skill and knowledge, but it will be appreciated that various other questions may be used. However, since the answers are pre-defined, there are limitations as to the level of detail that can be obtained.

For more detailed information and insight, screen portion 141 illustrates other questions, such as question 146, may solicit free form answers in a free form input box 148. By posing such an open-ended question, the member may expose particular strengths or weaknesses that could be difficult to unveil using objective questions alone. Finally, the member may be asked to provide target projections for a particular investment. Question 151 asks the member to predict the value of ABC stock, and type the target projections in projection box 153. More particularly, the member is asked to provide a 2-week projection 155, a 4-week projection 157, and an 8-week projection 159. It will be appreciated that other longer or shorter future time periods may be selected.

Referring again to FIG. 2, block 38 shows that the objective answers are filtered and analyzed to ascertain the experience and knowledge of the member. Further, certain patterns of answers may indicate particular strengths, while certain patterns of inconsistent answers may indicate particular weaknesses or even indicate a lack of forthrightness in answering the objective questions.

The free-form answers may also be reviewed, as indicated in block 43. More particularly, the free-form answer may contain particular words or phrases that indicate a skill or knowledge level, or the answer may be analyzed to find a pattern or progression that indicates particular strengths or weaknesses in this investment.

The new member's target projections can be compared to other members' target projections. For example, if the new member's targets are similar to a set of highly rated members, then that may indicate the new member is skilled or knowledgeable. In a similar manner, if the new member's targets are far from where more trusted members place the target value, then that may indicate the new member lacks particular skills or knowledge for this investment.

In block 49, the strength and weakness indications from blocks 38, 43, and 47 are combined to determine an initial new member rating. In a preferred example, members may be rated on a scale from 0.99 to 9.99, with 9.99 being the most skilled and credible member. However, due to the inherent uncertainties in setting a new member rating, a new member rating may be limited into a more restrictive range, such as 0.0 to 7.0. In this way, the extreme high ratings are reserved for those that prove their credibility over time. The target information provided by the new member may be processed and used to supplement the investment information as shown in block 52.

Once the member is registered and has an initial rating, the member is enabled to more fully utilize the features of method 30. For example, the register member is enabled to input written dialog 54. The written dialog may be, for example, messages posted to a message board or in a discussion forum, or in response to posts by other members in a discussion forum. These discussion forums are preferably arranged to address a particular investment opportunity. For example, there may be a discussion forum to address a particular publicly traded stock, a different discussion forum for commodities such as gold trading, and yet a different forum for an upcoming IPO.

The register member is also enabled and encouraged to provide target projections for the investments. These projections represent the best guess or speculation by the member as to how the investment will be valued at particular intervals in the future. In a specific implementation, the registered user may be required to submit target projections for an investment when posting a message in that investment's discussion forum. Accordingly, each time a member posts a message, the rest of the members will benefit from the accumulated knowledge and experience of every member. This provides increased efficiency and effectiveness in evaluating investment information and in making investment decisions.

Registered members can also search, filter, and otherwise analyze the investment information, as indicated in block 58. The investment information includes the dialog, target projections, and associated ratings for the members. Further, the investment information may include other information pre-loaded into the system, and information collected from other online services, such as current stock quotes.

Although each new member is assigned an initial rating, there is substantial value in adjusting the rating responsive to actual accuracy or performance and conduct of each member. In this regard, messages submitted by the member can be analyzed 63 for words or patterns that indicate particular strengths or weaknesses. Similarly, the target projections provided by a member can be compared to the targets provided by other members, and an indication of the member's ability and credibility may be ascertained. Further, even the process a member uses in analyzing data 67 may be reviewed to reveal a member with particular skills, expertise, and knowledge.

And possibly the most revealing, the accuracy 69 of the member can be compared to the actual value of the investment. Rating indicators 63, 65, 67, and 69 can then be used to adjust a member's rating, as shown in block 71. In this way, members that contribute strongly to valuable dialog, provide consistently accurate target predictions, and follow an intelligent analysis process are given the high ratings, and therefore their targets and comments may be afforded the most credibility or weight when making an investment decision.

The rating of a member may be used to control the input, access, and analysis rights for that member, as indicated in optional block 76. For example, higher rated members may be given more space for writing messages, or may be allowed to make predictions further into the future. Additionally, the higher rated members may be given more analysis or access rights, such as access to insight by experts or investment professionals, or other valuable investment information. In a variation, lower rated members may only be able to search, view, and use information from other like-rated members, while higher rated members could have access to all investment information. In this scenario, it may be possible that the lower rating member could pay an additional fee 78 to gain access to the projections and messages from higher rated members.

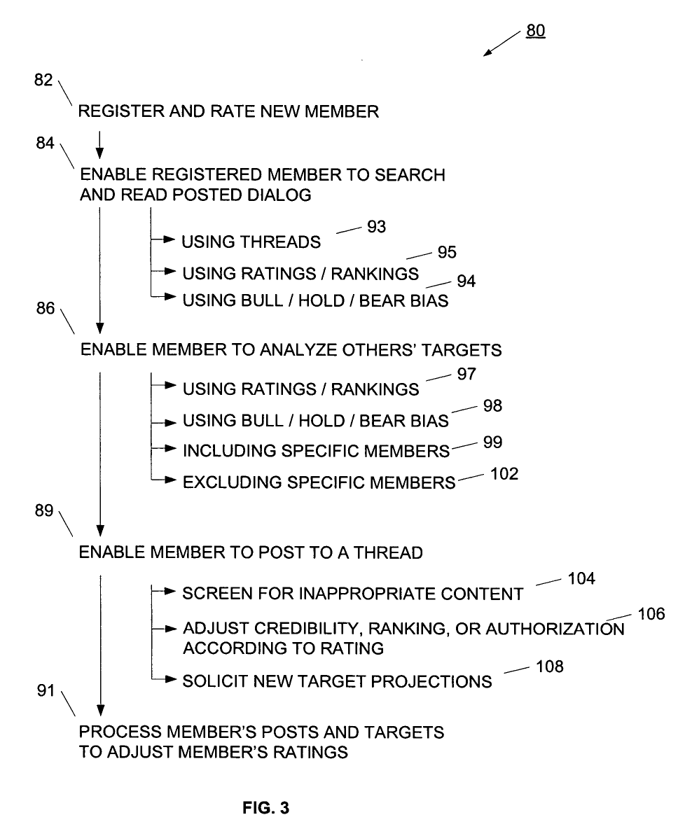

Referring now to FIG. 3, a particular implementation of a method 80 for managing investment information is shown. As with the methods previously discussed, method 80 has a new user go through a registration process and assigns an initial rating, as indicted in block 82. Method 80 includes a discussion forum having threaded message discussions. In this regard, a member can search, read, and respond to messages as shown in block 84. As with traditional discussion forums, the member may use threads 93 to navigate discussions, or, the member may use member ratings 95 to more efficiently navigate messages, and to put the message content in perspective. The member may also investigate other member's bias 94 toward making bear, bull, or hold projections. The use of ratings enables a member to easily avoid the time-consuming task of reading messages from members having unknown credibility, or who have shown a propensity to be wrong, and to concentrate efforts on more credible opinions from higher rated members.

Members are also enabled to use and analyze the target projections of other members, as shown in block 86. As above, member ratings or rankings 97 provide substantial assistance in the analysis process, and provide an easy-to-use indicia of the probable expertise and reliability of each member. The member may also investigate other member's bias 98 toward making bear, bull, or hold projections. Although the ratings provide a quick indicator, other factors may cause a member to believe that another member has been over or under rated. For example, if a particular member's dialog indicates a substantial depth of understanding of an investment, but that member's rating is low, it may be desirable to include that member in an analysis, irrespective of the low rating. Accordingly, the member could be expressly included in an analysis 99, even though the associate rating is low. In a similar fashion, a particular member with a high rating may make clearly erroneous statements in their dialog, indicating they reached the right valuation but using a wrong analysis. In this case, it would be desirable to exclude this member from the analysis, irrespective of that member's high rating.

The registered user can also post to a thread, as indicated in block 89. It may be desirable to screen messages prior to posting the message in the discussion forum. The message can be screened for inappropriate content 104, such as specific “bad” words or phrases, or a pattern that indicates a hostile, uncivil, or off-topic response. By screening out such messages, the civility and usefulness of the discussion forum is enhanced. Preferably, if a particular message is determined to have inappropriate content, then the offending member would be alerted and shown the terms and conditions of the discussion forum, and asked to rephrase their message. Repeated violations of the terms of service could result in suspension or termination of member rights, or other loss of rights.

Although every member may have some rights to post messages, it may be desirable to allow higher rated members to have more flexibility in composing messages, as shown in block 106. For example, higher rated members could be allowed to have longer messages, or more messages per session, and may even have relaxed screening for content. It is also convenient to have members include target projections when posting a new message, or when posting a response to another's message. It will be appreciated that the projections could be required for every post, or could be required at a different interval, such as with the first post in every session. As described earlier, a member's postings and target projections can be used to adjust that member's rating 91. According, the method 80 adapts and self-corrects according to the accuracy and proven skill of its members.

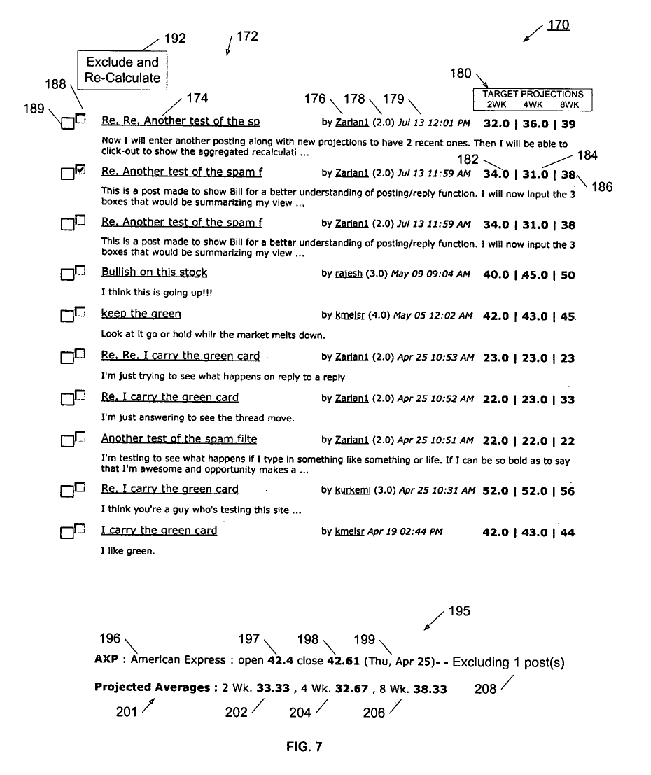

Referring now to FIG. 7, an example screen 170 is shown. Screen 170 may be, for example, a screen showing an implementation of method 80 described above. Screen 170 shows a thread of messages 172 in reverse chronological order. That is, the messages near the top were posted after messages towards the bottom of the screen. Each message, such as message 174, is identified by its subject matter, and includes the name of the member 176 that posted the message. That member's rating 178 is also shown, along with the date and time 179 of posting. Each message also includes target projections 180 provided by the member. Screen 170 shows that each message has a 2-week target 182, 4-week target 184, and an 8-week target 186 projections.

Each message also includes a checkbox 188 that enables a member to exclude that particular message from searches, analysis, and displays. Each message also includes another checkbox 189, which is used for excluding that message, and further excluding all messages from that same author. In this way, every projection from a particular member may be excluded from searches and analysis. It will be appreciated that other means may be used to indicate specific inclusions and exclusions from analysis.

Once exclusions have been identified using the checkboxes 188 and 189, the action button 192 can be used to recalculate target projections. The calculated projections are displayed in display area 195, with the display are 195 also including an indication of the particular investment 196, and actual opening 197 and closing 198 values on a particular date 199. The calculated projections 201 include the calculated 2-week target projection 202, the calculated 4-week target projection 204, and the calculated 8-week target projection 206. The display area also shows exclusions 208 from the calculation.

It will be appreciated that the calculation of the projected averages may be accomplished in several ways. For example, the calculation may simply present the average of the target projections that were selected for analysis. In another example, the calculation could be target projections according to the rating or the bias of the member providing the projection. It will also be appreciated that alternative rules may be presented for selection by a user. In this way, a particular user could make analysis selections to accomplish specific goals.

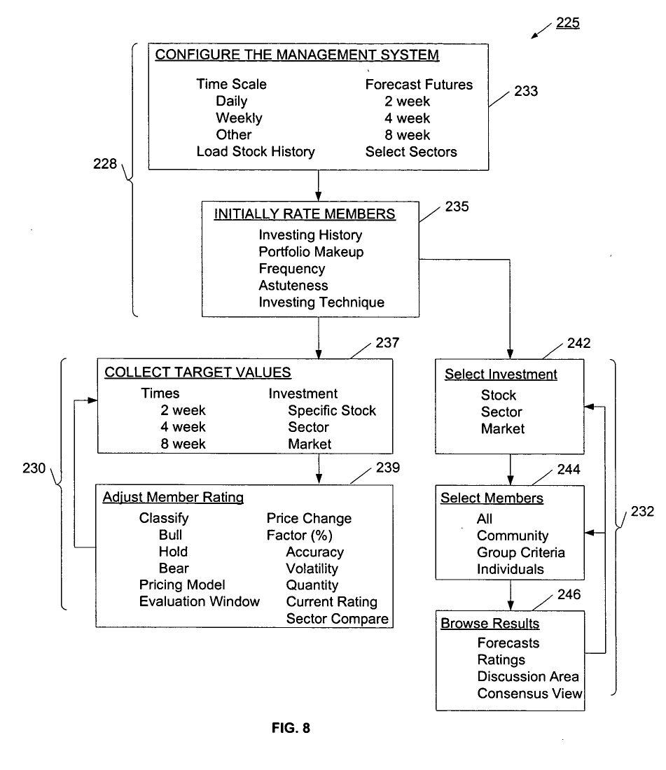

Referring now to FIG. 8 a method for managing stock information is illustrated. Although method 225 illustrates stock information, it will be understood that other investment instruments may be used. For example, method 225 may be used with minor modifications for managing commodity information, property information, bond information, and other financial information. Method 225 may be implemented on a networked computer system, such as the Internet. Method 225 may be implemented on a server system, or may have a more distributed system architecture. Method 225 is an automated process enabling member investors to accurately share information, do investment research, and may improve investing results and portfolio performance.

Method 225 generally comprises a set-up section 228, a member input section 230, and an information retrieval section 232. Although the members using method 225 may maintain a certain level of anonymity within the system, the system provides an adaptive rating system for each member to facilitate trust between members. In this way, method 225 allows members to accurately and unambiguously share information, while assisting each member in evaluating the credibility of other member input and contributions.

In using method 225, a system administrator first configures the management system as shown in block 233. For example, the system manager may determine the time scale the management system should use. For example, the management system may use a daily time scale for monitoring stock prices, target values, and member ratings. However, such a daily time scale may be overly cumbersome and provide little additional information over a longer time scale, such as a week. In one example of the management system, a weekly time scale is selected so that stock prices are determined within a weekly period, and a member sets stock targets according to an expected value in a week. Although a week is selected as a time scale, it will be appreciated that other time scales may be selected for specific investment strategies and investment instruments. For example, a day trader may desire a much faster time scale, while an investor dealing in property values may be satisfied with a longer time scale. The user or administrator of the management system may set the time scale for the target projections. The target projections are forecasts of an investment value in the future. For example, the system administrator may set the management system to have forecast times of 2 weeks, 4 weeks, and 8 weeks in the future. It will be understood that other forecast times may be used dependent on specific needs and the type of investment instrument.

The administrator also may provide for loading stock data from another source. For example, public and proprietary databases exist having substantial information on history of companies, stocks, and markets. This information may be loaded and directly used by members for research, and the information may also be used in assessing and setting member ratings. For example, the historic volatility of a stock value or other investment instrument may affect how the management system rates a member's forecast of that stock or instrument. By way of illustration, a member that accurately predicts a highly volatile stock has more value than a member who is able to accurately predict a very stable stock, and therefore should be rewarded with a higher member rating. The system administrator may also provide for identification of industry sectors. For example, the system administrator may define certain stocks as belonging to a telecommunications sector. These sectors may be defined by outside sources, or the management system may define proprietary sectors. Once the system has been configured, the system is ready to register investors as members of the system.

As an initial step, members register with the management system and are provided an initial rating as shown in block 235. The member rating is typically based on an arbitrary scale, for example, 0.99 to 9.99. In such a scale a member having a rating between 1 and 1.9 may be considered novice, a member having a rating between 2.0 and 3.9 may be considered a good investor, a member having a rating between 4 and 5.9 may be considered a very good seasoned investor, and those investors having a 6 or higher may be considered more expert investors. At initial registration, a maximum allowable rating may be set. For example, the system may set a maximum initial rating at 5.0, so that no member can be rated higher than a 5.0 initially. Since the management system may not be able to verify a member's registration information, the management system will limit the member's rating until the member has a proven track record within the management system. Although the member rating may be displayed with a single or double decimal of resolution, it will be understood that the method may internally account for a higher resolution, but limit the display resolution by rounding.

During registration each member may be asked for specific information, and may further be asked to answer a series of investing questions. Based on the responses to the questions, the management system will assign an initial rating to that member. For example, the registration process may investigate the investing history for a member. In one example, the management system may add 0.2 bonus points for each of the first 9 years that an investor has been actively investing. The system may assign an additional 0.2 bonus points for 15 or more years, and an additional 0.2 bonus points for 20 or more years of experience. In this way, a 2-year investor will receive 0.4 points, while a 25-year investor will receive 2.2 points. It will be appreciated that other methods may be used for assigning bonus points based on investment history.

The registration process may also inquire into the size of the member's public stock portfolio. Again, bonus points may be assigned based on the total value of the member's portfolio. For example, the management system could assign 0.1 points for each $50,000 in the member's public stock portfolio up to $1,000,000. Thus, a member could acquire a maximum of 2.0 points for having a large public stock portfolio. The management system may also inquire into the stock trading frequency. Again, the management system may assign points relative to the average number of trades made per month. In one example, the management system assigns 0.1 bonus points for every trade up to 18 trades per month. In this way, an active investor could be assigned up to 1.8 points for having 18 or more trades in one month.

The management system may also inquire into the general astuteness of the investor. In one example, the investor may be asked to self evaluate as to a level of competence and proficiency in the market, and in another example the investor may be asked specific questions related to that investor's portfolio performance. Either way, the management system can assign points, for example up to 1.8 points, depending upon the level of astuteness perceived by that member. In another factor, the management system may inquire into the number of hours spent researching investments per month, and investigate methods used by the member. For example, the management system may assign points for the number of hours spent researching per month, and may add more points if the member uses electronic databases or multiple data services. Again the management system would set a limit, for example 1.8 points, that the investor could be assigned based on the number of hours and methods used. The management system may also be configured to inquire as to other investing characteristics of the members, and use those characteristics to adjust the initial rating. It is possible that a very seasoned investor may have scores for each of the factors that aggregate to more than the maximum initial rating allowed by the system. In such a case, the member's score would be reduced to the maximum allowed as an initial rating, but the management system may use the raw initial rating as a factor to more quickly adjust the member's rating, provided the member participates and has accurate projections.

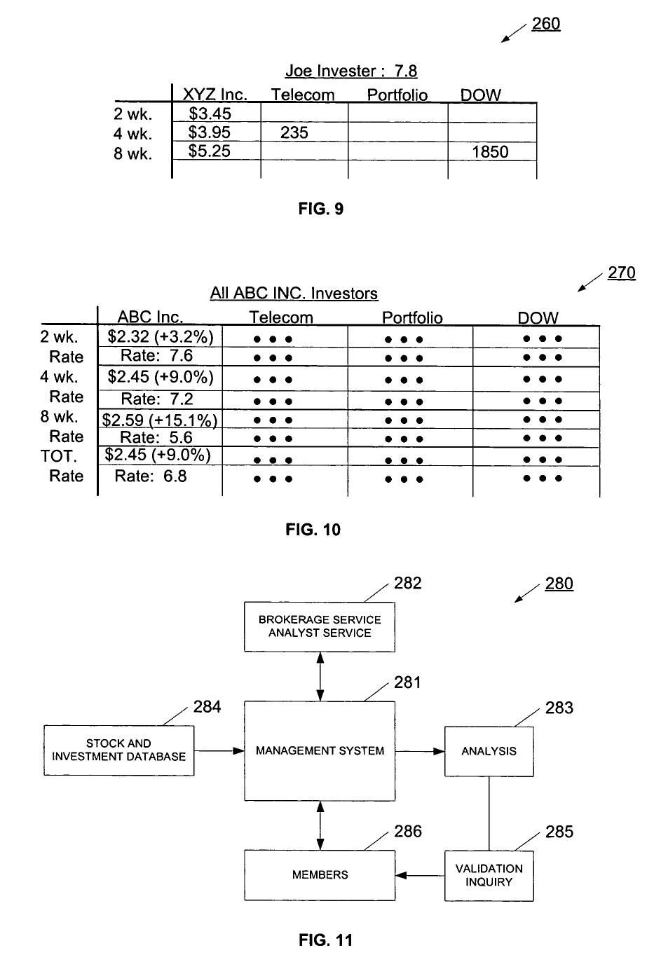

Once a member has registered and been assigned an initial rating, the member is permitted to input and share target projection information. Target projections are a number-based and provide a universal language for enabling investors to efficiently and unambiguously communicate. Each member would be encouraged to input target values as shown in block 237. The member would be invited to project the value for an individual stock, specific industry sectors, or for an entire market or exchange. The target projections may be set at 2 weeks, 4 weeks, and 8 weeks, for example. Referring to FIG. 9, an input screen for an experienced investor is illustrated. This investor is projecting that XYZ Inc. will have a stock price of $3.45 in 2 weeks, $3.95 in 4 weeks, and $5.25 in 8 weeks. He also believes that the telecomm sector will have a relative index of 235 while the DOW will be at 1850. These projections become part of the management system's database of information and may be useful to other members, and later will be used to adjust the member's rating. For example, if the investor shown in FIG. 9 accurately predicts the price of XYZ Inc., that investor's rating may increase. However, if the investor does a poor job of predicting future value, then that investor's rating is likely to go down.

Referring again to FIG. 8, the management system will adjust each member's rating as shown in block 239. As members continue to use the management system, the management system acquires an historical track record for each member. The member's target projections can then be compared to actual prices, and the management system may adjust the member's rating depending on the member's level of accuracy. Generally, the accuracy of a member is determined by comparing the member's target projection to the actual price of the stock. In a simple management system, the actual price may be set, for example, as the average closing price for the forecasted (target) week. In a more complex version of the management system, the management system may define actual price differently depending on whether the member is predicting strong growth, strong loss, or only a little change in stock price. In this case, the management system may define strong growth as a “bull” style forecast, a strong decline as a “bear” style forecast, and a prediction of little change would be a “hold” forecast.

In one specific example, the management system could define a bull forecast as any forecast that predicts more than 2% growth in 4 weeks or less, and more than 4% growth in 8 weeks. In a similar manner any prediction that forecasts more than a 2% loss in less than 4 weeks, or more than a 4% loss in 8 weeks would be considered a bear forecast, with all other forecasts considered a hold forecast. With the forecast classified as bull, hold, or bear, the management system would determine actual price differently for each of the 3 classifications. For example, for a bull forecast the management system may select the actual price to be the highest daily close in the target week; for a bear forecast the management system may select the lowest daily close in the forecast week, and for a hold forecast select the average of all daily closes. By aligning the selected actual price model to the style of prediction the investor was making, the system may more completely assess the investing style and skill of the member.

In a preferred example, the management system uses an evaluation window of one full week, which is typically 5 trading days. It will be appreciated that shorter or longer evaluation windows may be used for different types of investing and for different types of investment instruments. Once an actual price has been determined for a week, then a member's prediction accuracy may be calculated based on that member's forecast for that week. The level of accuracy may then be associated with an increase or decrease in the member's current rating. It will be appreciated that many alternatives exist for adjusting the member's rating. In one specific example, the management system adjusts the member's rating by a percentage each month. This percentage is related to several factors, including the accuracy of the member's forecast. In a simple example, the management system could identify each forecast as being good, bad, or neutral, and increase the member's score by 1% for a good forecast, decrease the member rating by 1% for a bad forecast, and keep the member's score the same for a neutral forecast.

Although accuracy is a key consideration for adjusting a member's rating, other factors may be used to more fully reflect the investor's skill level. For example, if the member accurately predicted a highly volatile stock, then the management system may award an additional percentage increase for such a prediction. On the other hand, the management system may reduce the penalty for having made a bad prediction for a highly volatile stock, but may increase the penalty for making a bad prediction for a very stable stock. In another example, the quantity and consistency of making good forecasts may be used to receive additional percentage gain in a member's rating. Those members that show active portfolios with consistent forecasts have an insight that is more valuable than members who rarely participate and are less consistent. Also, if the member accurately predicts a target value for a stock, and that stock acts contrary to that stock's sector, then the management system may reward the member with a higher percentage increase in rating. In such a case, the investor shows particular knowledge and skill by making an accurate prediction even when that stock's sector moved in the opposite direction.

Since the adjustment is made on a percentage basis rather than a raw number of points, it will also be appreciated that members with a higher current rating may have more movement per rating window. For example, if a member has a current score of 8 points and is awarded a 2% increase, that member's score would go up to 8.2 (+0.16 rounded). In another example, if a member had a rating of 4.0, and was awarded a 2% increase, that member's rating would only go up to 4.1 (+0.08 rounded). Even though the management system rounds the member rating for ease of display, the management system is likely to internally track 2 or 3 decimal places for increased accuracy. To provide stability in the management system and to mitigate the rewarding for a fluke of prediction accuracy, the management system will limit the percentage increase for each evaluation period to a maximum percentage, such as 2%. It will be appreciated that many other adjustment rating systems may be used consistent with this disclosure.

As described above, the management system collects target projections from its members, and dynamically adjusts the ratings of those members. In this way, each target projection has an associated rating so that others may judge the credibility of the projection. Over time, the management system becomes a valuable data warehouse of stock information, price projections, and member evaluations. Members may access and use this information to assist in making more efficient and effective investment decisions.

In using the management system 232, a member selects a particular investment of interest as shown in block 242. For example, the member may be interested in investigating a particular stock, a specific market sector, or an entire market or exchange. The member then may select which of the system's members to evaluate as shown in block 244. The member may be interested in seeing how all other members view a particular investment or may be interested in understanding how other specific groups or even individuals analyze that investment. Members may join into communities of common interest, and a member may be able to investigate how a particular community is viewing an investment. For example, a community may comprise investment bankers, and others may be interested to see how the investor banking community is viewing a particular sector. In another example, a member may be able to set particular criteria of members and then see how that group views an investment. Here, the member may be presented an inquiry selection form, and the member may select the criteria of members of interest. The management system would then interrogate its database of members and provide a display of how those members forecast a particular investment. Also, a member may be interested in tracking how a specific individual or small group of individuals view a stock. For example, if a particular investor or small group of investors has shown particular accuracy in a sector, a member may be interested in tracking that particular investor or group of investors.

After the member has selected the members of interest, the member is able to browse the results as shown in block 246. For example, the results may include forecasts made by the members and those members' ratings. In one example, FIG. 10 shows a display screen of how all ABC Inc. investors forecast the future stock price of ABC at 2 weeks, 4 weeks, and 8 weeks. As shown in the example in FIG. 10, ABC investors predict 3.2% growth by 2 weeks, 9% growth by 4 weeks, and a 15.1% growth by 8 weeks. However, the member ratings are relatively high for 2 weeks and 4 weeks, but drop considerably for the 8 week rating. In this way, an investor may view this display to show that ABC Inc. investors have been reasonably accurate out to 4 weeks, but have a more difficult time accurately predicting to 8 weeks. Finally, after browsing the results, a member may choose to go into a discussion area to further discuss investment opportunities and compare analysis results with other members.

Referring now to FIG. 11 another management system is shown. Management system 280 includes a computerized management system 281 similar to the management systems described with reference to FIG. 7. The management system 281 is preferably a network computer system allowing members access to common information and results of the management system 281. The management system 281 may receive information from a stock and investment database 284. The information may be loaded when configuring the management system 281, or may be continually updated over time. The management system 281 may also be coupled to a brokerage service 282. The brokerage service may facilitate additional research tools, and may also enable members to directly link to the brokerage service for buying and selling investments, or the management system may be configured to automatically buy and sell investments using brokerage service 282.

In one specific application, the management system 281 performs an analysis 283 on information received by the management system 281. For example, the management system may automatically detect that members are predicting a sharp increase in a particular stock price. The management system 281 could analyze its member database to find members that have previously provided accurate information regarding that stock, that stock's sector, or the market in general. The management system 281 could then prepare a validation inquiry 285 to be sent to those selected members. For example, the validation inquiry could be in the form of e-mail to the members informing the members of the activity projected for that stock, and asking if each of the selected members agrees or disagrees with the projected increase in value. In this way, the management system intelligently identifies significant changes projected in the market, and acts to automatically validate those changes. It will be appreciated that many other types of analyses and validation inquiries could be made consistent with this disclosure.

While particular preferred and alternative embodiments of the present invention have been disclosed, it will be appreciated that many various modifications and extensions of the above described technology may be implemented using the teaching of this invention. All such modifications and extensions are intended to be included within the true spirit and scope of the appended claims.

What is claimed is:

1. A method for managing investment information, comprising:
registering a member;
soliciting investment experience data from the member;
associating an initial rating with the member responsive to the investment experience data;
presenting to the member investment information collected from other members regarding an investment;
receiving a target projection from the member, the target projection being a speculation of a value of the investment in the future;
including the target projection in the investment information; and
adjusting the initial rating of the member to an adjusted rating responsive to the accuracy of the target projection.

2. The method according to claim 1, wherein the soliciting element further includes receiving initial projection targets for a test investment; comparing the initial projection targets to targets derived from the investment information; and using the comparison in determining the initial rating.

3. The method according to claim 1, wherein the soliciting element further includes requiring the member to answer an investment experience question by selecting one or more predetermined answers.

4. The method according to claim 1, wherein the soliciting element further includes requiring the member to answer an investment experience question by inputting a free-form response.

5. The method according to claim 4, further including processing the free-form response for a word pattern indicative of an investment skill level.

6. The method according to claim 1, further including filtering the investment information according to member rating.

7. The method according to claim 1, further including filtering the investment information by excluding specific members.

8. The method according to claim 1, wherein presenting the investment information includes presenting other member dialog in the form of posts for a discussion group.

9. The method according to claim 1, wherein presenting the investment information includes presenting an indicia of member ratings.

10. The method according to claim 1, further including receiving the target projection for the investment in a specific time period.

11. The method according to claim 10, wherein the time period is N weeks in the future, and the target projection is a speculation of the average value of the investment in the time period.

12. The method according to claim 11, wherein the time period is one week.

13. A method for managing investment information, comprising:
rating a member's investment experience responsive to registration information collected from the member;
displaying to the member system target projections indicative of target projections received from other members, target projections being a speculation of a value of an investment in the future;
receiving from the member a new target projection for the investment; and
adjusting the member's rating according to the accuracy of the new target projection.

14. The method according to claim 13, further including filtering the target projections received from other members to determine system target projections, the filtering using ratings associated with the other members.

15. The method according to claim 13, further including receiving from the member dialog data.

16. The method according to claim 13, including processing the dialog data to locate a word pattern.

17. The method according to claim 16, further including restricting the dialog data responsive to the located word pattern.

18. The method according to claim 16, further including adjusting the member's rating responsive to the located word pattern.

19. A method for managing investment information, comprising:
receiving target projections from a plurality of members, each target projection being a speculation of a value of an investment in the future;
rating each member according to the accuracy of their respective target projections;
determining a system target projection using the target projections and associated ratings;
presenting the system target projection to a particular member;
receiving from the particular member, responsive to the system target projection, an updated target projection; and
including the updated target projection and the particular member's rating in determining a new system target projection.
